(19) United States
(12) Patent Application Publication
(10) Pub. No.: US 2007/0291437 A1
(43) Pub. Date: Dec. 20, 2007

(54) Power Regulator Supplied to Electric Charges of Industrial Processes

(75) Inventors: Maurizio Cornali, Provaglio D'Iseo (Brescia) (IT); Fabio Baga, Provaglio D'Iseo (Brescia) (IT)

Correspondence Address: AKERMAN SENTERFITT, P.O. BOX 3188, WEST PALM BEACH, FL, 33402-3188, US

(73) Assignee: Gefran S.p.A., Provaglio d'Iseo (Brescia) (IT)

(21) Appl. No.: 11/424,715

(22) Filed: Jun. 16, 2006

(51) Int. Cl. H01H 47/00

(52) U.S. Cl. 361/142

(57) ABSTRACT

The present invention relates to a regulator of the power supplied to industrial process electric loads comprising a power module and a control module, wherein the power module comprises a solid-state switching relay associated to a heat dissipator and the control module comprises a Programmed Logic Controller or PLC which attends to controlling the load switching relay; the control module is equipped with connections to the different sensors being required for the industrial process correct operation. Advantageously, the regulator comprises at least two or more solid state relays (1, 2, 3, 4) housed in the power module and individually controlled by the central logic unit of said Programmed Logic Controller (CPU), in order to power different electric loads having a different load cycle from each other.

### FIELD OF APPLICATION

The present invention relates to a regulator of the power supplied to industrial process electric loads wherein the component configuration achieves a higher versatility in the use and control of variable electric loads having a different variation cycle from each other.

More precisely, the invention relates to the configuration of the power regulator for industrial process electric loads wherein the load variability requires the power regulator itself to be sized with a load capacity corresponding to the highest capacity achievable by the respective electric load. The power regulator device is of the type intended to be mounted on a control board or panel associated to the process management machine.

### PRIOR ART

As it is well known to the skilled in the art, power regulators for industrial process electric loads comprise a power module and a control module, for controlling one or more resistors with a heating/cooling logic depending on the type of load to be managed.

In particular, in the plastic material working machine field, it is often necessary to provide regulator devices of the resistor heating power in order to precisely thermoregulate the temperature in the plastic material melting areas and in the mould areas wherein the plastic material configuration occurs. Said regulators of the power supplied to electric loads are associated in the machine control boards side by side assembled in tens of devices by skilled personnel.

It is known in the art that the power module comprises a solid-state switching relay associated to a heat dissipator and the control module comprises a Programmed Logic Controller or PLC, which attends to controlling the load switching relay.

The switching-generated heat is dissipated by means of a dissipator while the adjacent PLCs and/or regulators are interconnected by means of a data bus allowing the communication between said regulators, for a specific and controlled machine programming.

Moreover the different sensors being required for the industrial process correct operation refer to said control module; these sensors are connected to the PLC or control module of the power regulator they refer to.

Electric load power regulator embodiments, which also comprise, besides the data bus, power electric connections for the main electric line or for an auxiliary electric line, are also known in the prior art.

Nevertheless, when different loads having a power varying in time are to be controlled, it is known in the art to set the power regulators with a highest threshold corresponding to the highest power that such specific load can require. From this approach it results that the power regulators are all sized for the highest suppliable power even when the respective loads do not require the use thereof. It results that the power modules of each regulator are sized for the highest suppliable power, subsequently having a corresponding relay at the suitable power solid state. In order to determine the module dimensions, the sizing of the corresponding switching-generated-heat dissipator is even more relevant, being just sized for the highest suppliable power.

Furthermore, control modules do not undergo size variations with the controlled power so that the regulator dimensions are primarily represented by the dissipator size. Several adjacent power regulators in the control board rack have obviously a considerable area occupation for the heat dissipator size.

The technical problem underlying the present invention is to arrange the elements composing the power regulator so that several regulators can be put side by side in the control board reducing the dimensions, obviously for the same performances.

Another aim of the invention is to reduce the production and maintenance costs of the electric load power regulator, both during the installation and in the following maintenance.

### SUMMARY OF THE INVENTION

This and the other aims are achieved according to the present invention by a regulator of the power supplied to industrial process electric loads comprising a power module and a control module, wherein the power module comprises a solid-state switching relay associated to a heat dissipator and the control module comprises a Programmed Logic Controller or PLC, which attends to controlling the load switching relay; the control module is equipped with connections with the different sensors being required for the industrial process correct operation: these sensors are connected to the PLC or control module of the power regulator they refer to; said regulator being characterised in that it has at least two or more solid state relays housed in the same power module and individually controlled by the central logic unit, of said Programmed Logic Controller, in order to power different electric loads having a different load cycle from each other.

The power module and the control module are included in a same chassis, delimitating the overall size of the regulator of power.

The connectivity between such a regulator and the display-terminals or the working machines is considerably improved: in fact the power module is directly connected to the control module inside the chassis so that the display-terminals or the working machines may directly be connected to the regulator and without intermediate wiring to a control module external to the regulator of power.

As it will be clear from the following description, the control module is on board with respect to the power module so to detect a plurality of function parameters in a proximity space with respect to the power module, in more quickly and accurately way.

More particularly, the size of the regulator of power is substantially reduced through a specific management of the dissipator and the corresponding power modules, such management being directly driven by the control module. Also the cost of the overall regulator of power is reduced, as well as its user management that is supported by a plurality of specific functions driven by the control module.

Last but not least, the security of the regulator of power is improved through a plurality of control means, designed to alert a human user through specific alerts, to send a control signal to a control display-terminal or eventually to stop the furniture of the regulator of power.

The features and advantages of the present invention will be apparent from the following description of an embodiment thereof given by way of non limiting example with reference to the attached drawings.

### BRIEF DESCRIPTION OF THE DRAWINGS

FIG. 1 is a block diagram of the elements composing the regulator of the power supplied to electric loads according to the invention;

FIG. 2 is a perspective view from the above of the power regulator from the side of the electric load connection board;

FIG. 3 is a perspective view from the above from the side of the aeration fan;

FIG. 4 is a sectional view of the power regulator according to the invention;

FIG. 5 is a power supply diagram for electric loads having a balanced absorption;

FIG. 6 is a similar diagram to the previous figure, but with electric loads having a different power absorption.

### DETAILED DESCRIPTION OF A PREFERRED EMBODIMENT

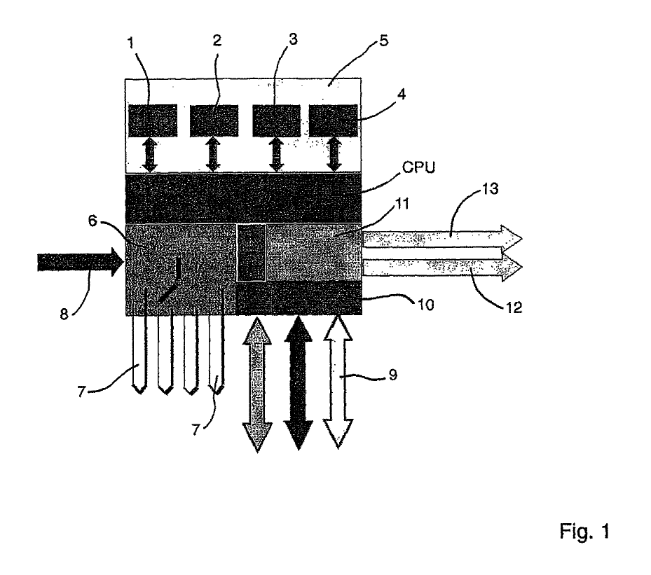

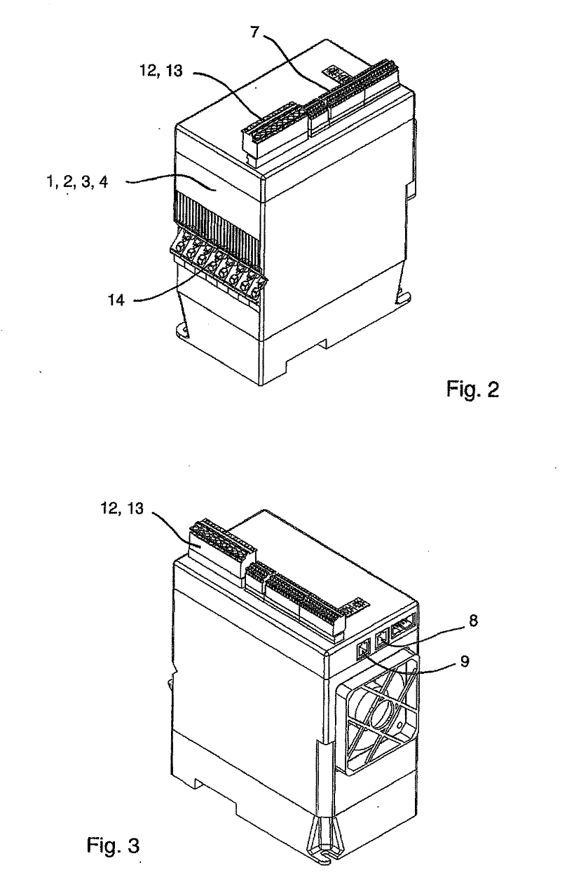

With reference to these drawings, and particularly to the block diagram of FIG. 1, the power modules 1, 2, 3, 4 are shown, comprising each a solid state relay, but all physically associated to the same dissipator 5.

These relays are electrically controlled by the central logic unit CPU, which receives input electric signals coming from a plurality of sensors 7.

The logic unit CPU also receives analogue/digital supplied power data from a sensing board 15, being described hereafter, and by means of timed input connections 6, it reads at regular intervals the signals detected by the sensors 7.

A single control module CPU is interconnected by means of a logic connection bus 8 and 9 to an external industrial process control processor by means of a network interface 10.

The central unit CPU also provides a plurality of output data gates 11 with digital alarm signals 12 and digital control outputs 13, being configurable according to the function (for example for the cooling control).

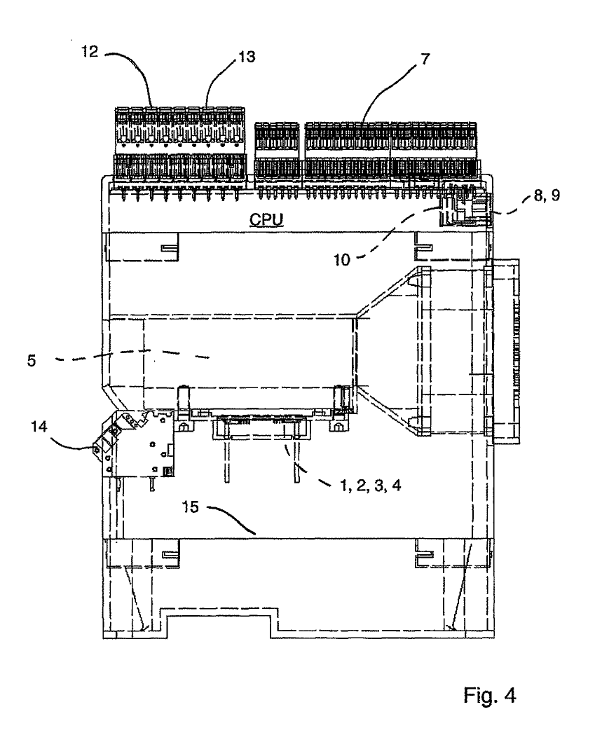

Some connection boards 14 for the connection to electric loads regulated by the controlled power supply and a driven load electric parameter sensing board 15 can be also seen in FIGS. 3 and 4.

The board 15 sends the detected data to the central unit CPU and the latter exchanges data with the interface 10 and it sends the control signals to the power unit solid state relays 1, 2, 3 and 4.

According to the present invention a single control module is associated to more than one power modules for managing the corresponding power supply. More particularly, a size of the regulator of power, comprising said more than one power modules, is smaller than a size of a regulator of power according to the prior art, rendering the connection with the working machine and/or display-terminals easier and faster.

The dissipator included in the regulator of power is shared between more than one power modules and a single control module, also embedded inside the regulator of power, is used to drive all the power modules.

The single control module is in fact embedded inside a chassis also comprising the power modules and is strictly near its electric basic components. The proximity between the power modules and the single control module allows to detect directly and without wiring connection, a plurality of working parameters of the power modules. For example, a value of dissipation of temperature, a value of electricity inside each relay, a voltage at counter-pose loadings, a frequency voltage, a correct working state of a cooling fan may be precisely detected.

No wiring are required for carrying control signals from a power module to the control module, being the power modules and the single control module connected together inside the chassis delimitating the regulator of power.

More particularly, each power module, the control module and each additional module inside the chassis are interconnected trough fast connections, so that the regulator of power may be assembled and de-assembled in simple steps and without requiring the intervention of a specific technician.

One of this module comprises a cooling fan that is interconnected through a fast connection to the control module. An example of the modularity of the regulator of power is given by the possibility to substitute the cooling fan by simply unlocking its connection with the control module and rapidly re-connecting a new cooling fan.

According to the present invention, the size of the regulator of power is reduced through the sharing of more than one additional modules between more than one power modules, as described with reference to the control module. The cooling fan itself is a shared module used to air cool the dissipator linked to all the power modules.

More particularly, the chassis according to the invention comprises an especial slot for the cooling fan, appositely designed to route the air cool moved by the cooling fan towards the dissipator and towards electric components requiring to be cooled.

The regulator of power according to the present invention, comprises a plurality of additional modules, included inside the single chassis, limiting the physical burden of the regulator of power and, at the same time, reducing the production and maintenance costs of the electric load power regulator, both during the installation and in the following maintenance.

Advantageously, in the same limited space, the regulator of powers also provides an external modular connection to additional external modules. For example, an external module comprising a plurality of protection fuses intended to protect a corresponding plurality of electric components inside the regulator of power, may be mounted on such external modular connection. In other words, the external modular connection is specifically designed to protect or drive, through an external module, one or more internal electric component of the regulator of power.

The regulator of power provides a plurality of connections towards external display-terminals and sensors, for instance RJ10 or RJ45 connections, intended to communicate with the control module, for example to remotely control or drive the power modules. Advantageously, also these plurality of connections may be modularly inserted and/or replaced inside the chassis comprising the power and control modules.

The regulator of power according to the present invention also provides security means intended to protect the electronic components during the supply of power to the industrial process. More particularly, the security means are implemented in the control module and, for instance, provides a temporary suspending or decreasing of power supplying when the loads are too high.

The control module instantaneously detect a plurality of function parameters of the power module, due to its direct connection with the power modules inside the chassis of the regulator and without wiring connections. In this way, the control module may immediately activate the security means.

The security means for example drive the cooling fun faster, when the temperature is over an acceptable threshold or they stop such a cooling fun when the temperature is acceptable.

The control module, detects immediately an high temperature of the power module, being in proximity with such modules, and alert a display-terminal with a corresponding advise or a human user, for example with an acoustic message.

It is worth to note that the regulator of power is really smaller in size with respect to a prior art regulator, at the same time the control power guaranteeing the same power supply with especial improvement in the management of each single power module, as it will be clear by the example given hereinafter, non limiting in the number of power modules given.

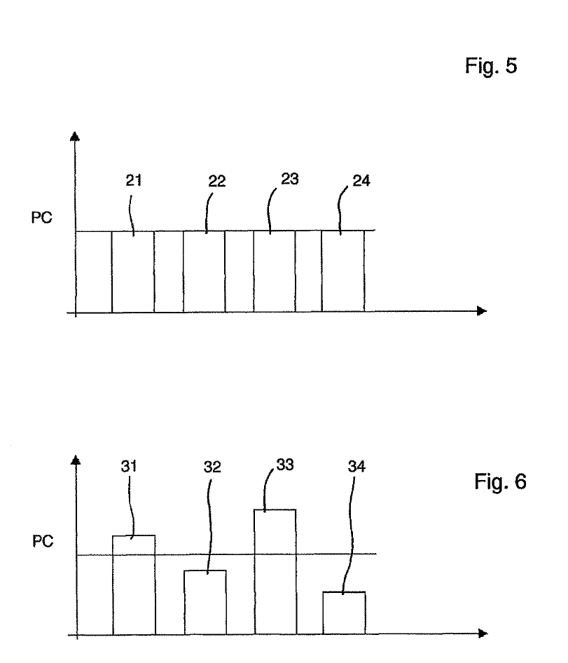

FIG. 5 is a diagram of the power supplied to the loads indicated with 21, 22, 23 and 24 having a balanced absorption and an average power PC. The supplied power is PCx4, i.e. the highest nominal power of the power regulator whereto the dissipator 5 and each solid state relay 1, 2, 3 and 4 are sized.

FIG. 6 is a diagram of the power supplied to the loads indicated with 31, 32, 33 and 34 having a different absorption. The supplied power does not exceed PCx4, i.e. the nominal power. Some loads, for example the ones indicated with 31 and 33, considering the higher power at which solid state relays can operate, have higher powers than PC, while other loads, indicated with 32 and 34, have lower powers. However the total of the supplied powers does not exceed the nominal power PCx4.

The regulator of power is not limited to supply the same load to each power module; in fact the control module may detect the specific load required by each single power module so to distribute a higher load to a power module requiring such higher load and, consequently, a lower load to one or more respective power modules not requiring the higher load. The control module provides that the total amount of power supplied by the regulator of power corresponds to the nominal power PCx4.

The regulator of power may limit the supplying of power to the power modules in order to prevent too high electric absorption on the line of a network. More particularly, when the working machines are cold, typically during their start up phase, the electric request and absorption is near to 100%, until the reaching of a set-point temperature.

In this case, the control module drives a percentage of power per each power module, so that the total percentage of power supplying is under a prefixed threshold, less than 100%.

According to the control module it is also possible to set a priority on different power modules. For example, if a first power module has a high priority and requires a high furniture, the effective furniture to a second and-or a third and or a fourth power module, associated to a lower priority, may be suspended.

According to the present invention, the control module may also provide configuration means in order to set a value for the nominal power, for example reducing it when a high furniture is contemporary required by all the power modules or when a network for the industrial process is not designed to support such a nominal power.

If the total amount of power required by one or more power modules exceeds a predetermined threshold, the control module suspend a supplying of power to one or more power modules.

Advantageously, a single control module CPU, a single interface board 10 and a single electric parameter sensing board 15 are used to manage more than one loadings and they are shared when used to connect the power units to the process control logic units.

In fact, when driven loads have the same absorption, as shown in FIG. 5, the power supplied on each load is limited to the nominal power divided by the number of the existing and active loads. While, in case of different absorption between the loads, as it can be seen in FIG. 6, the instantaneous total of the power supplied on the loads is limited to the nominal power, but the power on some loads can be higher than the average power PC and meanwhile on the remaining loads the supplied power must be lower than the average power.

The achievable advantages result in a sizing of the power module being limited to a single dissipator for the nominal power and to the four solid state relays so that each one can support by itself the nominal power, while the control module CPU is not correlated to the value of the power involved in the power module and it also controls all solid state relays so to always use the nominal power even when some loads do not require any power or in a limited way while some others require more power.

The compensation of the supplied instantaneous powers thus allows the power supply to be managed by a single device, which, in the simplest embodiment thereof, can even comprise only two solid state relays, thus capable of powering two independent loads.

The best advantages, compensating the power module structural complexity with several solid state relays and the possible reciprocal compensation between the powers supplied on the loads, are obtained by the shown configuration of four solid state relays, i.e. to power four different electric loads, and a single control module with logic control and interface units with the control board of the machine wherein said regulator is installed.

The modularity of four solid-state switching relays, provided by the control module, avoid an un-efficient employment of the regulator of power, especially in industrial processes wherein the electrical loads are limited. In fact, in these industrial processes, a regulator of power according to the prior art and comprising solid-state switching relays 8, 12, 16, 24 is more expensive and more size consuming with respect to the regulator of power according to the present invention.

Anyway, the regulator of power according to the present invention is compatible with structurally different regulator of powers, each provided by an arbitrary number of solid-state switching relays.

In fact, the control module may be easily interconnected to one or more structurally different regulator of powers, such interconnection satisfying any requirement on an industrial process by providing a arbitrary number of solid-state switching relays. Said arbitrary number is given by a sum of the number of solid-state switching relays included in the regulator of powers according to the present invention and the number of solid-state switching relays included in the interconnected structurally different regulators of power.

The modularity of four solid-state switching relays also allows to modify a specific of functioning of the control module, depending on the loads required by the industrial process, through a simple and user friendly configuration, not requiring a substitution of electric components or connections to the regulator of power.

For example, four mono-phase electric loads may be powered, each being independently managed by the control module or a tri-phase load together with a single mono-phase load may be powered, according to two different management by the control module. Also a two bi-phase loads may be powered, respectively with two different management by the control module.

In conclusion, the following advantages provided by the regulator of power according to the present invention may be resumed.

The power module and the control module are embedded in a same chassis with a size substantially smaller with respect to known regulators of power supplied to industrial process electric loads.

The regulator of power is connected to the working machines directly through the control module embedded inside it, without requiring expensive and cumbersome wiring from the working machines to an external control module and from this last to a power module.

Advantageously, also the connection between the regulator of power and the display-terminal is driven by the control module embedded inside it, being a plurality of different connections, based on different standard communication protocols, supported in a versatile way by such control module.

Advantageously, the control module on board of the regulator of power has an high accuracy to detect function parameters of the regulator, for example reading the dissipation temperature, the electricity inside each relay, the voltage at counter pose loadings, the frequency voltage, the correct state of working of the cooling fan and so on.

All the above cited function parameter may be modified for example remotely through the display-terminal connected to the regulator of power, in order to optimise its performance and to safeguard it, for example in dangerous condition of power or temperature.

The control module allows to reduce at a minimum scale the dimension of the regulator of power, using a unique dissipator for more than one relay. Advantageously, the control module manages contemporary all the relay optimising the productivity of the relative power module. According to the present invention the cost of the regulator of power is reduced, being its security contemporary enhanced.

Obviously, aiming at meeting specific and incidental requirements, a skilled in the art will be able to bring several changes to the above-described regulator of the power supplied to industrial process electric loads, all comprised, however, within the scope of protection of the present invention as defined by the following claims.

1. A regulator of the power supplied to industrial process electric loads comprising a power module and a control module; the power module comprising a solid-state switching relay associated to a heat dissipator and the control module comprising a Programmed Logic Controller or PLC in order to control the corresponding electric load switching relay; said control module being connected to different sensors required for the industrial process correct operation, characterised in that the power module houses at least two or more solid state relays individually controlled by a central logic unit of the Programmed Logic Controller (CPU), in order to power different electric loads having a different load cycle from each other.

2. A power regulator according to claim 1, wherein it comprises four solid state relays housed in the power module and controlled by the central logic unit (CPU).

3. A power regulator according to claim 1, wherein the overall nominal power supplied to electric loads by the power module corresponds to the total of the powers supplied by each of said solid state relays.

4. A power regulator according to claim 1, wherein at least one of the relays incorporated in the power module can supply an electric power corresponding to the regulator nominal power.

5. A power regulator according to claim 1, characterized by comprising a chassis including, in proximity and in a close delimited space, said control module and said power module.

6. A power regulator according to claim 5, wherein a fast connection inside said chassis provides a fast connection-disconnection between said control module and said power module.

7. A power regulator according to claim 6, wherein said chassis comprises a plurality of additional slots for hosting a corresponding plurality of additional modules intended to be fast connected-disconnected to said control and-or power modules through corresponding plurality additional fast connections.

8. A power regulator according to claim 7, wherein one of said plurality of additional modules comprises a cooling fun intended to air cool said power module.

9. A power regulator according to claim 8, wherein one of said additional slots hosts said cooling fun, delimitating a routing for air cooled toward said power module.

10. A power regulator according to claim 1, wherein said control module detects a plurality of function parameters of said power module, comprising a value of dissipation of temperature and-or a value of electricity inside each of said solid-state switching relays and-or a voltage at counter-pose of said loads and-or a frequency voltage of electricity and-or a rotational speed of said cooling fan, said function parameters being instantaneously detectable due to said proximity between said control module to said power module.

11. A power regulator according to claim 4, wherein said control module comprises configuration means to set a value of said overall nominal power.

12. A power regulator according to claim 11, wherein a said control module supplies one or more different values of said electric loads to corresponding one or more different of said power modules, corresponding to said at least two or more solid state relays, depending on a request of power of said power modules and on said overall nominal power.
